(19) United States
(12) Patent Application Publication
(10) Pub. No.: US 2011/0314003 A1
(43) Pub. Date: Dec. 22, 2011

(54) TEMPLATE CONCATENATION FOR CAPTURING MULTIPLE CONCEPTS IN A VOICE QUERY

(75) Inventors: Yun-Cheng Ju, Bellevue, WA (US); Wei Wu, Seattle, WA (US); Ye-Yi Wang, Redmond, WA (US); Xiao Li, Bellevue, WA (US)

(73) Assignee: MICROSOFT CORPORATION, Redmond, WA (US)

(21) Appl. No.: 12/817,233

(22) Filed: Jun. 17, 2010

(51) Int. Cl. G06F 17/30

(52) U.S. Cl. 707/723; 707/766; 707/E17.074; 707/E17.014

(57) ABSTRACT

Architecture that provides the capability to identify which parts (terms and phrases) of a voice query have been covered by predefined phrase templates, and then to concatenate matching phrase templates into a new paraphrased query. A match-drop-continue algorithm is disclosed that progressively masks out the portions (phrases, terms) of the query matched to the phrase templates. Ultimately, the matched phrase templates are accumulated and organized together dynamically into a rephrased version of the original voice query. A user interface is provided that allows the user to confirm/summarize the multiple concepts in a progressive manner.

### CROSS-REFERENCE TO RELATED APPLICATIONS

This application is related to pending U.S. patent application Ser. No. 12/329,406 entitled “REPLYING TO TEXT MESSAGES VIA AUTOMATED VOICE SEARCH TECHNIQUES” filed on Dec. 5, 2008, the entirety of which is incorporated by reference herein.

### BACKGROUND

Voice search is a technology underlying many spoken dialog systems that provide users with the information requested via a spoken query. The information normally exists in a large database, and the spoken query is compared with a field in the database to obtain the relevant information. A typical voice search system operates by attempting to first recognize a user utterance using automatic speech recognition (ASR) that comprises an acoustic model, a pronunciation model, and language model, for example. The best results are returned by the ASR for further processing, and user interaction can also be employed to further refine the voice search query results.

Paraphrase detection is utilized for more efficiently organizing the message template sets. However, for existing paraphrase processing algorithms, it is difficult to obtain adequate coverage for multiple concepts (phrases) in the voice search due to the exponential nature of the number of possible combinations. There are no practical solutions to address the performance issues caused by multiple-concept queries.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides the capability to identify which parts (terms and phrases) of a voice query (search) have been covered by predefined phrase templates, and then concatenates those templates to return paraphrased text. A match-drop-continue algorithm is disclosed that progressively masks out the portions (phrases, terms) of the query matched to the phrase templates. Ultimately, the matched phrase templates are accumulated and organized together dynamically into a rephrased version of the original voice query. A user interface is provided that allows the user to confirm/summarize the multiple concepts in a progressive manner.

The architecture can be applied to many voice search related applications, such as like voice-mail summarization, template-based speech-to-speech translation, voice-enabled local search, etc.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system that processes voice input into text in accordance with the disclosed architecture.

FIG. 2 illustrates an alternative embodiment of a system that employs a user interface.

FIG. 3 illustrates a detailed example of a user interface for interacting to summarize and confirm voice search information.

FIG. 4 illustrates a computer-implemented method that processes voice input into text in accordance with the disclosed architecture.

FIG. 5 illustrates further aspects of the method of FIG. 4.

FIG. 6 illustrates an alternative method that processes voice input into text.

FIG. 7 illustrates further aspects of the method of FIG. 6.

FIG. 8 illustrates a block diagram of a computing system that executes multi-concept paraphrase detection and template concatenation in accordance with the disclosed architecture.

### DETAILED DESCRIPTION

The disclosed architecture includes techniques to identify which part of a query is covered by a predetermined phrase template. By masking out the covered portions (matched to a phrase template) of the query, the retrieval procedure can continue on the remaining portions of the query to effectively concatenate templates dynamically and in the proper order to return a text message based on the concatenated templates.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

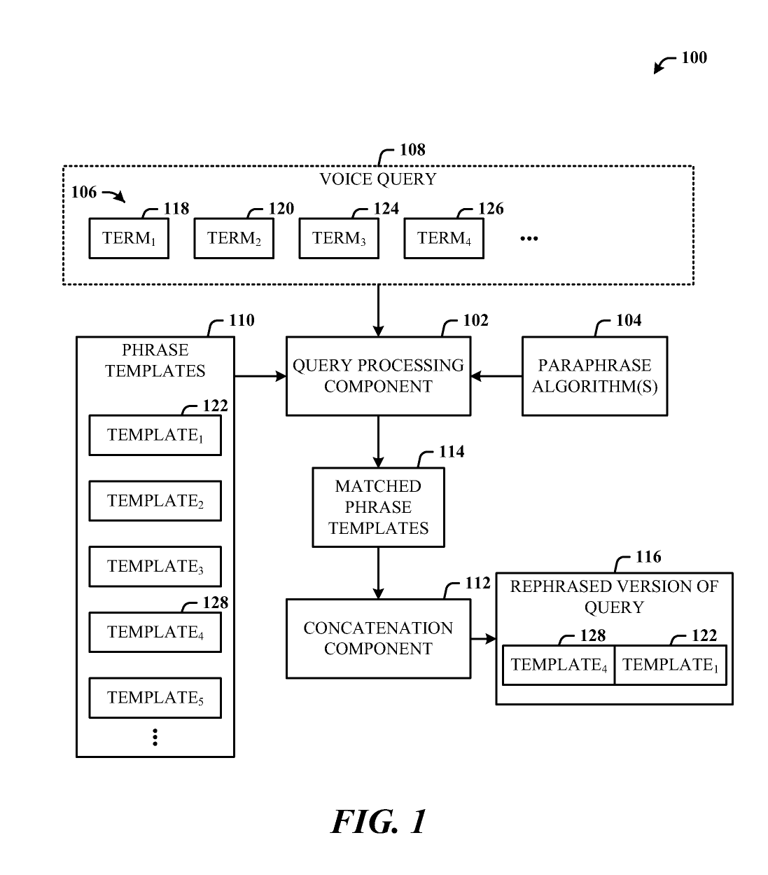

FIG. 1 illustrates a system 100 that processes voice input into text in accordance with the disclosed architecture. The system 100 includes a query processing component 102 that applies one or more paraphrase algorithm(s) 104 progressively on terms 106 of a voiced query 108 according to predefined phrase templates 110. The terms 106 can be single words or groups of words. The terms 106 when grouped properly form phrases (also referred to as concepts) for paraphrase detection processing. In addition, one or more terms in the voice query 108 are matched by templates in the phrase templates 110. For example, the voice query “I'll see you in front of your building at 5:00” comprises three terms “I'll see you”, “in front of your building”, and “at 5:00” and which may be matched by two templates “I'll meet you at 5:00” and “in front of your building”.

Thus, the voice query 108 will include multiple concepts some of which will not match perfectly with the predefined phrase templates 110. Accordingly, paraphrase processing is performed to match the concepts in the voice query 108 to the phrases in the phrase templates 110. Once a concept is matched to a phrase template, the template is passed to a concatenation component 112, which dynamically concatenates the matched phrase templates 114 to create a rephrased version of the query 116. Thus, the matched templates 114 are paraphrases relative to the concepts originally expressed in the voice query 108.

For example, if it is detected that a first term 118 and a third term 124 together are related closely (e.g., semantically) to terms in a similar phrase as defined in a first template 122, then the first template 122 is selected as a match and, the first and third terms (118 and 124) are removed (also called “dropped”) from the query 108 as being processed. Processing then continues on the remaining terms (e.g., a second term 120). If it is detected that the second term 120 is related closely to terms in a similar phrase as defined in a fourth template 128, then the fourth template 128 is selected as a match and, the second term 120 is removed from the query 108 as being processed. Processing then continues on the remaining terms.

It can be the case where certain terms 106 are dropped and the process completes at the system's discretion. Note that the system 100 can be configured to impose one or more constraints that regulate quality of the output according to a threshold (e.g., a maximum number of templates, relevancy of the templates to terms, etc.).

In this example, the first and fourth templates (122 and 128) are then processed through the concatenation component 112, which then combines the templates (122 and 128) into an order such that the template terms when presented to the user as the rephrased version of the query 116 convey the similar thought (concept) to the user as originally presented in the voice query 108.

The query processing component 102 and the concatenation component 112 can be part of a mobile communications system that processes the voice query 108 as a message (e.g., SMS). The query processing component 102 employs an information retrieval algorithm to find relevant templates from the phrase templates 110 to optimally cover (match) the terms 106. The relevant templates retrieved from the phrase templates 110 are sent to the paraphrase algorithm(s) 104.

The paraphrase algorithm(s) 104 perform paraphrase detection on the voice query 108 for terms that match a phrase template. The paraphrase algorithm(s) 104 remove terms from the query 108 which match a phrase template. The paraphrase algorithm(s) 104 progressively updates the query based on the removed terms for continued paraphrase processing until completed. The paraphrase algorithm(s) 104 can employ an n-gram translation model for paraphrase detection. The paraphrase algorithm(s) 104 can employ a logistic regression model for paraphrase detection.

Consider the following example. Two phrase templates (e.g., of the phrase templates 110) are provided: a first template “I'll meet you at 5:00” and a second phrase template “in front of your building”. Traditional processing techniques cannot accommodate the multi-concept query “I'll see you in front of your building at 5:00” because the query contains two concepts. Using the disclosed form of paraphrase detection, the paraphrase algorithm 104 first selects one phrase template “I'll meet you at 5:00” (the match step), identifies that this phrase template covers the concept “I'll see you . . . at 5:00” part of the query, and removes those terms from the query (a drop step), leaving only the modified query “in front of your building”, which can be matched by the second template (a continue step). As a result, the architecture dynamically concatenates the two matched phrase templates in the proper order and returns the rephrased version of the query 116 as “I'll meet you at 5:00 in front of your building”, which is appropriate.

The same approach can be used in other applications such as voice mail summarization (e.g., “Let me see if I got it right . . . you want him to pick you up . . . after work . . . as soon as possible”). This segmented structure also provides a natural and reliable way (as a user interface) or for the user to correct the misrecognitions (e.g., “no, pick up the kids”) and mobile local search (e.g., “Starbucks Coffee” “in Bellevue Square”).

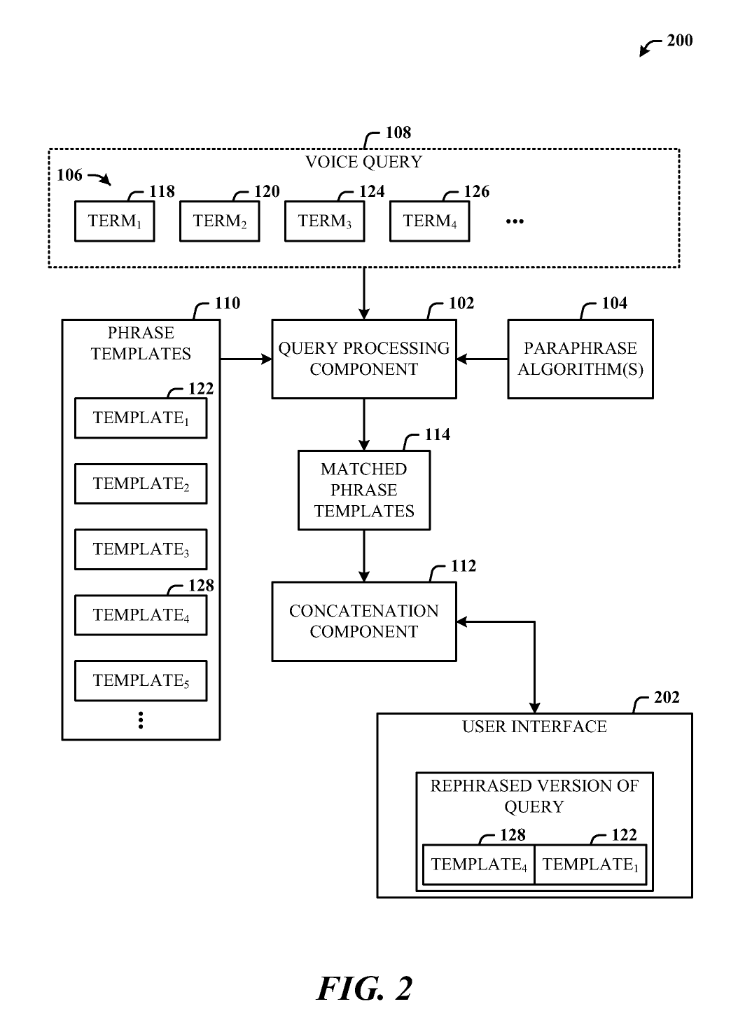

FIG. 2 illustrates an alternative embodiment of a system 200 that processes voice input into text and that employs a user interface 202. The user interface 202 can be utilized to present summarization and confirmation of multiple concepts of the voiced query 108 in a progressive manner. The system 200 includes the query processing component 102 that applies one or more paraphrase algorithms 104 progressively on the terms 106 of a voice query 108 according to predefined phrase templates 110 and the concatenation component 112 which dynamically concatenates matched phrase templates 114 to create the rephrased version of the query 116.

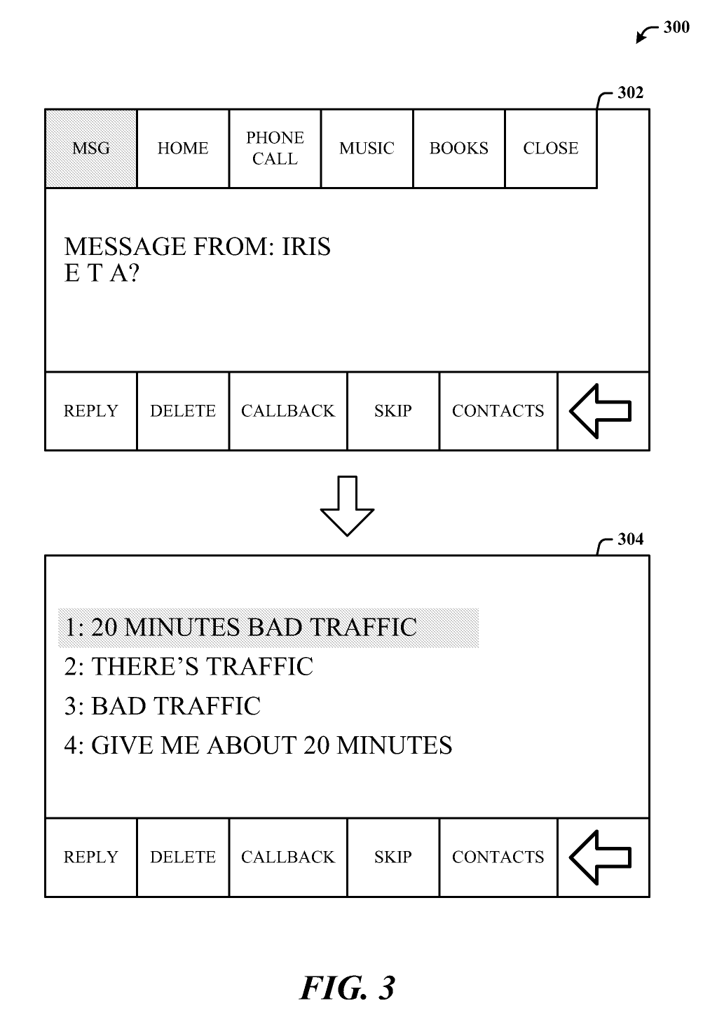

FIG. 3 illustrates a detailed example of a user interface 300 for interacting to summarize and confirm voice search information. In a first screen 302, a message is received and output to a user in an audio format and text format. The user responds with “bad traffic, in twenty minutes”. Query processing and concatenation results in four ranked and concatenated phrase template suggestions. In a second screen 304, the concatenated suggestions are presented to the user for manual or voiced selection. The top ranked template combination is rephrased and presented as “20 minutes bad traffic”. The user can then confirm the selection, voice another selection, and so on, according to the appropriate menu selections (e.g., Reply, Delete, Skip, etc.) along the bottom of the user interface 304.

To address the constraints of the concept template sets in general, and SMS messaging in particular, following is a description of paraphrase processing that employs n-gram translation and/or logistic regression models for paraphrase detection.

Machine translation techniques can be successfully extended to paraphrase generation. Paraphrase sentences are the translation result from the original sentences. In one implementation, an n-gram translation model can be employed for paraphrase detection.

Consider labeled paraphrase template pairs in a training set. A template pair (S,T) is aligned monotonically to obtain a sequence of word pairs as follows,

(S, T)=((s₁, t₁), (s₂, t₃), . . . , (s_{L}, t_{L})

where a null word is added, if desired. Each word pair (sᵢ, tᵢ) is treated as a single semantic unit and used to train a standard n-gram language model.

The probability of an aligned paraphrase template pair is represented as follows,

$$P ( ( S , T ) ) = {\prod }_{i} P ( ( {s}_{i} , {t}_{i} ) \vert ( {s}_{i - n + 1} , {t}_{i - n + 1} ) , … , ( {s}_{i - 1} , {t}_{i - 1} ) ) \qquad ( 1 )$$

The initial alignment is obtained by minimizing edit distance. The alignment and n-gram model is then iteratively updated to maximize the likelihood of the n-gram language model. The n-gram translation model exploits word-level paraphrases in unigrams with higher order n-gram context.

To exploit discriminative knowledge from non-paraphrase template pairs in the training set, a second n-gram translation model is also trained with labeled non-paraphrase template pairs as an anti-model. During the paraphrase detection, the detection score is computed as

s((S, T))=log P((S, T))−w log Pₐₙₜᵢ((S, T) (2)

where w is the anti-model weight. The weight is tuned on the development set by minimizing detection error rate.

There can be many template pairs which share formal similarity but are non-paraphrases due to discrepancy on a few keyword pairs. To handle such cases in the paraphrase detection, additional discriminative power can be obtained by employing logistic regression to train a discriminative paraphrase detection model. A logistic regression model can be defined as,

$$\begin{matrix}P ( Y = 1 \vert f ) = \frac{1}{1 + exp ( {w}_{0} + {\sum }_{i = 1}^{n} {w}_{i} {f}_{i} )} & ( 3 ) \\ P ( Y = 0 \vert f ) = \frac{exp ( {w}_{0} + {\sum }_{i = 1}^{n} {w}_{i} {f}_{i} )}{1 + exp ( {w}_{0} + {\sum }_{i = 1}^{n} {w}_{i} {f}_{i} )} \\ where , \\ Y = \{ \begin{matrix}1 , & paraphrase \\ 0 , & non \text{-} paraphrase\end{matrix} & ( 4 )\end{matrix}$$

fᵢ is the i-th feature defined on a pair of templates, and wᵢ is its correspondent model parameter. The logistic regression model is trained with gradient ascent with L2 normalization.

The disclosed architecture employs “part-of-message” enhanced edit distance alignment. Steps to extract features for logistic regression-based paraphrase model include aligning template pairs and extracting word-pair-related features from the template pair alignment. Traditional edit distance alignment does not consider semantic knowledge, and thus, cannot always produce proper alignment results. Accordingly, “part-of-message” processing is employed to analyze the semantic structure of messages (e.g., SMS). A “part-of-message” process classifies words in the message into semantic types (e.g., eight), as shown in Table 1 below.

TABLE 1
Definition of “Part-of-Message” Tags

| Tag | Description | Examples |
|---|---|---|
| P | common prefix, usually appears at the | yes, no, sure |
| | beginning of a message | |
| S | subjective words | I, you, I'll |
| V | verb and status words | get there, on my way |
| T | time words | in <d> minutes, soon |
| L | location words | in front of your building, |
| | | Coffee Shop |
| Q | question words | when, can you, what's up |
| C | condition words | if, when, as soon as |
| O | others, consists of words other than the | cool, hmm, darling |
| | above types | |

A linear conditional random field (CRF) model is trained to label “part-of-message” tags for message templates. After obtaining the “part-of-message” labeling, template pairs are aligned by minimizing the “part-of-message” (POM) enhanced edit distance, in which the word pair alignment cost is defined as,

C_{POM-Enhanced}(sᵢ, tᵢ)=C(sᵢ, tᵢ)+C_{POM}(POM(sᵢ), POM(t₁)) (5)

where C(sᵢ, tᵢ) is a traditional edit distance alignment cost between word sᵢ and tᵢ; POM(s) and POM(tᵢ) are “part-of message” tags of word sᵢ and tᵢ, and, C_{POM}(POM(sᵢ),POM(tᵢ)) is the alignment cost between two “part-of-message” tags, which is defined heuristically.

Since words corresponding to V, T, L, Q and C contain key information in messages (e.g., SMS), aligning one of the words to a word with a different “part-of-message” tag is assigned a higher alignment cost. Table 2 shows an example of heuristically defined “part-of-message” alignment cost.

TABLE 2
“Part-of-Message” Alignment Cost

| | V | T | L | Q | C | P | S | O | NULL |
|---|---|---|---|---|---|---|---|---|---|
| V | 0 | 2 | 2 | 2 | 2 | 2 | 2 | 2 | 1 |
| T | 2 | 0 | 2 | 2 | 2 | 2 | 2 | 2 | 1 |
| L | 2 | 2 | 0 | 2 | 2 | 2 | 2 | 2 | 1 |
| Q | 2 | 2 | 2 | 0 | 2 | 2 | 2 | 2 | 1 |
| C | 2 | 2 | 2 | 2 | 0 | 2 | 2 | 2 | 1 |
| P | 2 | 2 | 2 | 2 | 2 | 0 | 1 | 0 | 0 |
| S | 2 | 2 | 2 | 2 | 2 | 1 | 0 | 1 | 0 |
| O | 2 | 2 | 2 | 2 | 2 | 0 | 1 | 0 | 0 |
| NULL | 1 | 1 | 1 | 1 | 1 | 0 | 0 | 0 | 0 |

After obtaining the template pair alignment, features such as word pair n-grams, identical word pair ratio, and part-of-message discrepancy can be extracted for the logistic regression-based paraphrase detection model.

Word pair n-grams ((sᵢ₋ₙ₊₁,tᵢ₋ₙ₊₁), . . . ,(sᵢ,tᵢ)) in aligned template pairs are extracted as features. For a specific template pair alignment, the word pair n-gram feature is defined as,

$$f ( ( {s}_{i - n + 1} , {t}_{i - n + 1} ) , … , ( {s}_{i} , {t}_{i} ) ) = \{ \begin{matrix}1 , & if ( ( {s}_{i - n + 1} , {t}_{i - n + 1} ) , … , ( {s}_{i} , {t}_{i} ) ) exists in the alignment \\ 0 , & if ( ( {s}_{i - n + 1} , {t}_{i - n + 1} ) , … , ( {s}_{i} , {t}_{i} ) ) does not exist in the alignment\end{matrix}$$

To minimize the damping effect of the overwhelming number of identical word pairs, only non-identical word pair n-grams are used as features. For example, word pair n-grams such as ((be, be)), ((there, there)) and ((be, be), (there, there)) are discarded, while ((be, get)) and ((be, get), (there, there)) are retained.

The identical word pair ratio is defined as the number of identical word pairs in the template pair alignment divided by the alignment length. The ratio evaluates the formal similarity between the two templates.

For each of the eight “part-of-message” tags, such as P, the P “part-of-message” discrepancy feature as

$$f ( P ) = \{ \begin{matrix}1 , & P exists or does not exist in both templates \\ 0 , & P exists in only one of the two templates\end{matrix}$$

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

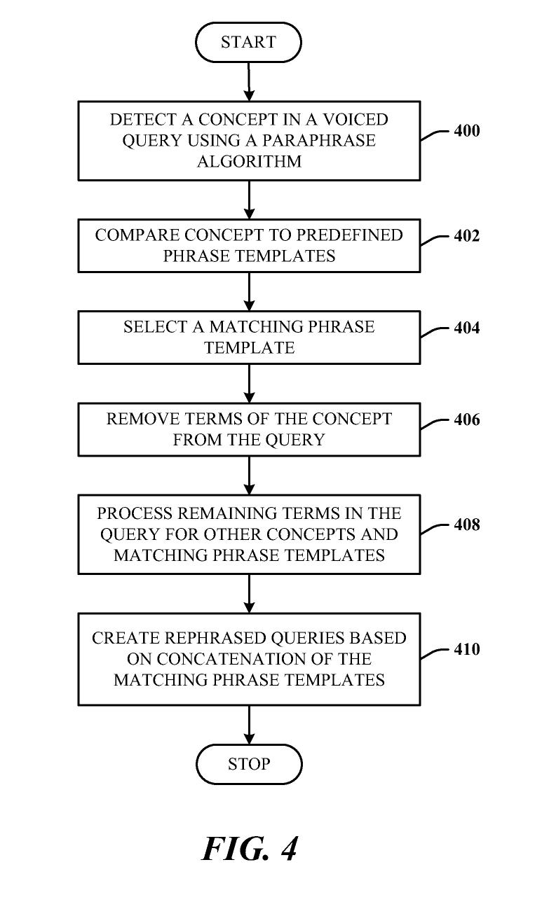

FIG. 4 illustrates a computer-implemented method that processes voice input into text in accordance with the disclosed architecture. At 400, a concept in a voiced query is detected using a paraphrase algorithm. At 402, the concept is compared to predefined phrase templates. At 404, a matching phrase template is selected. At 406, terms of the concept are re moved from the query. At 408, remaining terms in the query are processed for other concepts and matching phrase templates. At 410, rephrased queries are created based on concatenation of the matching phrase templates.

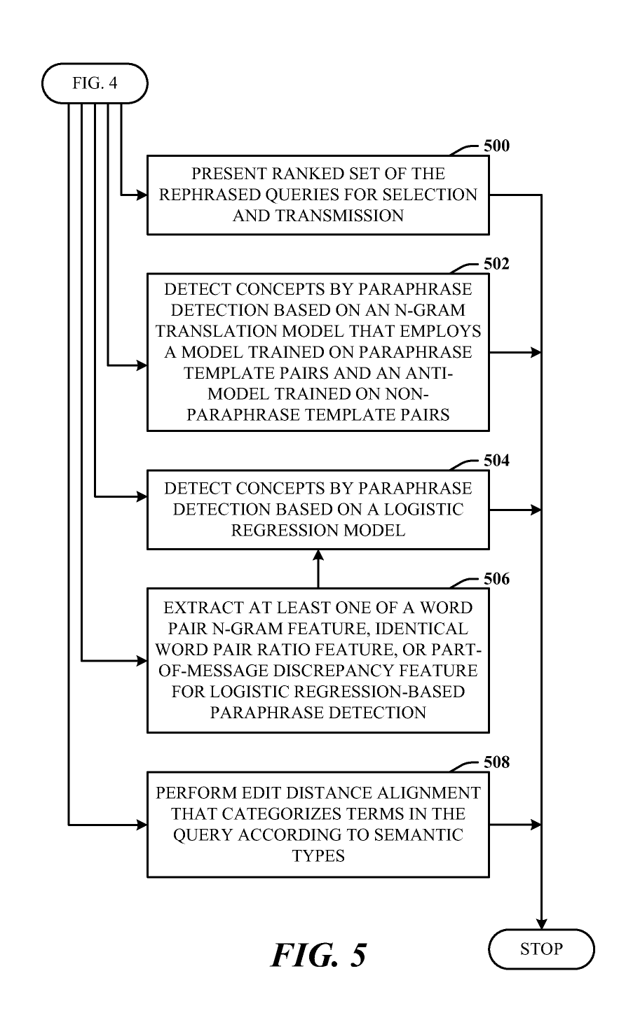

FIG. 5 illustrates further aspects of the method of FIG. 4. Note that the arrowing indicates that each block represents a step that can be included, separately or in combination with other blocks, as additional steps of the method represented by the flow chart of FIG. 4. At 500, a ranked set of the rephrased queries is presented for selection and transmission. At 502, the concepts are detected by paraphrase detection based on an n-gram translation model that employs a model trained on paraphrase template pairs and an anti-model trained on non-paraphrase template pairs. At 504, the concepts are detected by paraphrase detection based on a logistic regression model. At 506, at least one of a word pair n-gram feature, identical word pair ratio feature, or part-of-message discrepancy feature are extracted for logistic regression-based paraphrase detection. At 508, edit distance alignment that categorizes terms in the query is performed according to semantic types.

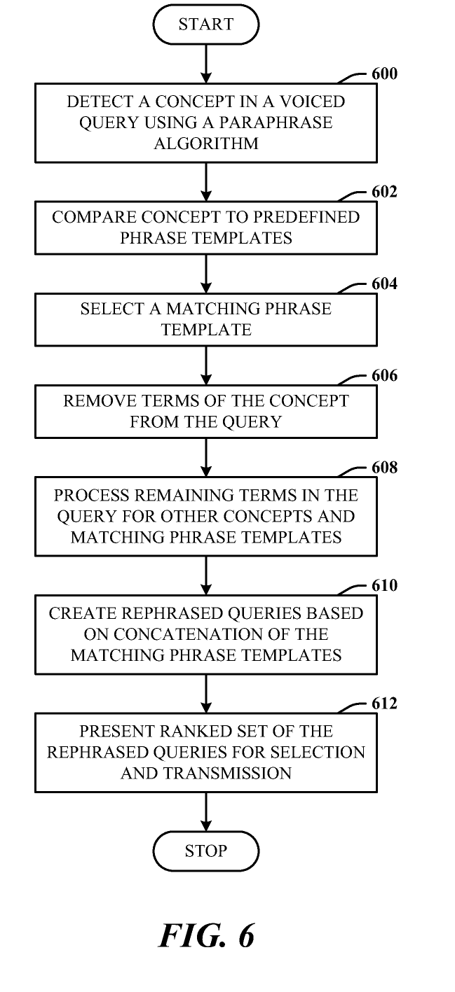

FIG. 6 illustrates an alternative method that processes voice input into text. At 600, a concept in a voiced query is detected using a paraphrase algorithm. At 602, the concept is compared to predefined phrase templates. At 604, a matching phrase template is selected. At 606, terms of the concept are removed from the query. At 608, remaining terms in the query are progressively processed for other concepts and matching phrase templates. At 610, queries are rephrased based on concatenation of the matching phrase templates. At 612, a ranked set of the rephrased queries is presented for selection and transmission.

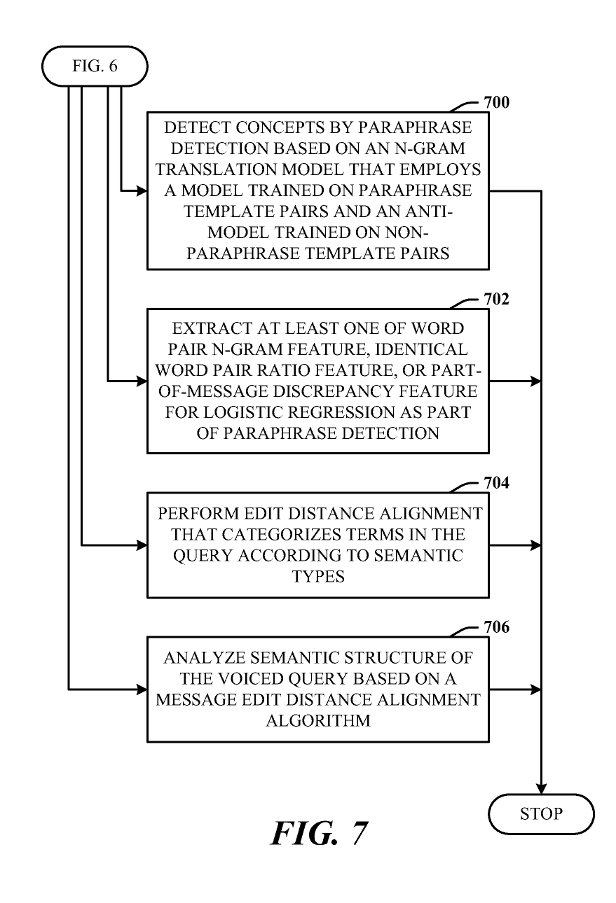

FIG. 7 illustrates further aspects of the method of FIG. 6. Note that the arrowing indicates that each block represents a step that can be included, separately or in combination with other blocks, as additional steps of the method represented by the flow chart of FIG. 6. At 700, the concepts are detected by paraphrase detection based on an n-gram translation model that employs a model trained on paraphrase template pairs and an anti-model trained on non-paraphrase template pairs. At 702, at least one of a word pair n-gram feature, an identical word pair ratio feature, or part-of-message discrepancy feature for logistic regression as part of paraphrase detection. At 704, edit distance alignment is performed that categorizes terms in the query according to semantic types. At 706, semantic structure of the voiced query is analyzed based on a message edit distance alignment algorithm.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

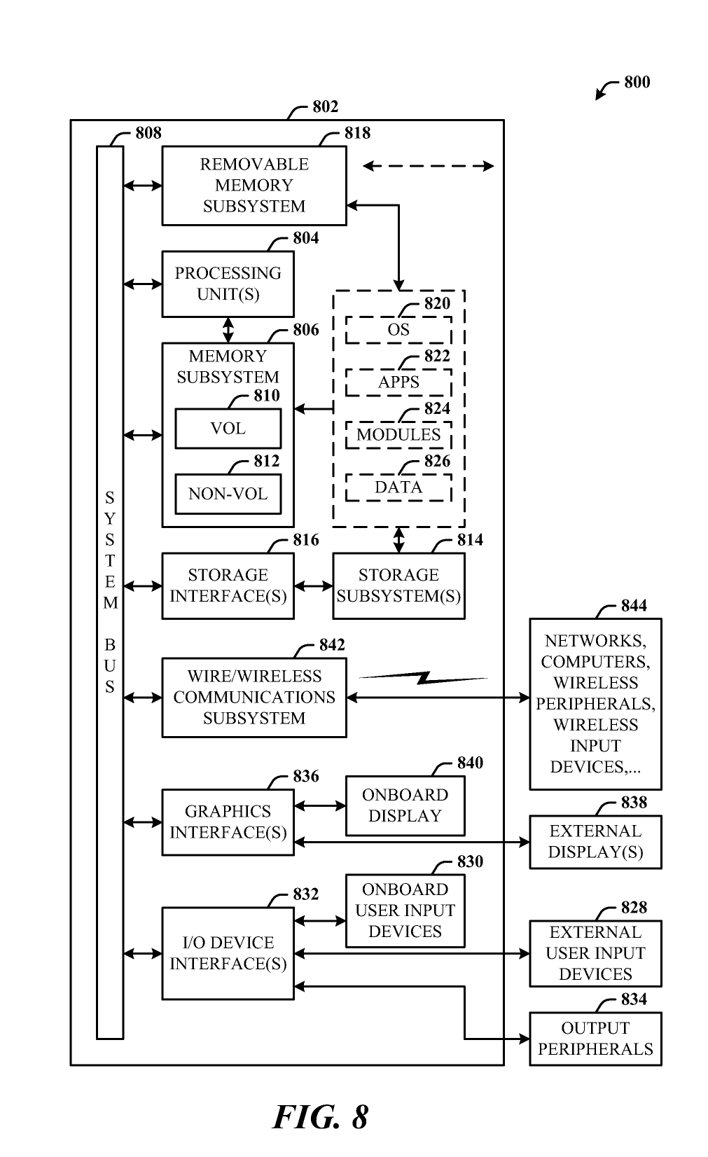

Referring now to FIG. 8, there is illustrated a block diagram of a computing system 800 that executes multi-concept paraphrase detection and template concatenation in accordance with the disclosed architecture. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage (physical storage media) such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The one or more application programs 822, other program modules 824, and program data 826 can include the entities and components of the system 100 of FIG. 1, the entities and components of the system 200 of FIG. 2, the user interface 300 of FIG. 3, and the methods represented by the flowcharts of FIGS. 4-7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that processes voice input into text, the system having computer readable media that store executable instructions executed by a processor, comprising:
a query processing component that applies a paraphrase algorithm progressively on terms of a voiced query according to predefined phrase templates; and
a concatenation component that dynamically concatenates matched phrase templates to create a rephrased version of the query.

2. The system of claim 1, wherein the paraphrase algorithm performs paraphrase detection on the voiced query for terms that match a phrase template.

3. The system of claim 2, wherein the paraphrase algorithm removes terms from the query which match a phrase template.

4. The system of claim 3, wherein the paraphrase algorithm progressively updates the query based on the removed terms for continued paraphrase processing until completed.

5. The system of claim 1, wherein the paraphrase algorithm employs an n-gram translation model for paraphrase detection.

6. The system of claim 1, wherein the paraphrase algorithm employs a logistic regression model for paraphrase detection.

7. The system of claim 1, wherein the query processing component and the concatenation component are part of a mobile communications system that processes the voiced query as a message.

8. The system of claim 1, wherein the query processing component employs a message edit distance alignment algorithm to analyze a semantic structure of the voiced query.

9. The system of claim 1, further comprising a user interface that presents summarization and confirmation of multiple concepts of the voiced query in a progressive manner.

10. A computer-implemented method executed by a processor to process voice input into text, comprising:
detecting a concept in a voiced query using a paraphrase algorithm;
comparing the concept to predefined phrase templates;
selecting a matching phrase template;
removing terms of the concept from the query;
processing remaining terms in the query for other concepts and matching phrase templates; and
creating rephrased queries based on concatenation of the matching phrase templates.

11. The method of claim 10, further comprising presenting a ranked set of the rephrased queries for selection and transmission.

12. The method of claim 10, further comprising detecting the concepts by paraphrase detection based on an n-gram translation model that employs a model trained on paraphrase template pairs and an anti-model trained on non-paraphrase template pairs.

13. The method of claim 10, further comprising detecting the concepts by paraphrase detection based on a logistic regression model.

14. The method of claim 13, further comprising extracting at least one of a word pair n-gram feature, identical word pair ratio feature, or part-of-message discrepancy feature for logistic regression-based paraphrase detection.

15. The method of claim 10, further comprising performing edit distance alignment that categorizes terms in the query according to semantic types.

16. A computer-implemented method executed by a processor to process voice input into text, comprising:
detecting a concept in a voiced query using a paraphrase algorithm;
comparing the concept to predefined phrase templates;
selecting a matching phrase template;
removing terms of the concept from the query;
progressively processing remaining terms in the query for other concepts and matching phrase templates;
creating rephrased queries based on concatenation of the matching phrase templates; and
presenting a ranked set of the rephrased queries for selection and transmission.

17. The method of claim 16, further comprising detecting the concepts by paraphrase detection based on an n-gram translation model that employs a model trained on paraphrase template pairs and an anti-model trained on non-paraphrase template pairs.

18. The method of claim 16, further comprising extracting at least one of a word pair n-gram feature, an identical word pair ratio feature, or part-of-message discrepancy feature for logistic regression as part of paraphrase detection.

19. The method of claim 16, further comprising performing edit distance alignment that categorizes terms in the query according to semantic types.

20. The method of claim 16, further comprising analyzing semantic structure of the voiced query based on a message edit distance alignment algorithm.
